(19) United States
(12) Patent Application Publication
(10) Pub. No.: US 2012/0274187 A1
(43) Pub. Date: Nov. 1, 2012

(54) LIBRARY APPARATUS

(75) Inventor: Koujiro HASHIMOTO, Kawasaki (JP)

(73) Assignee: FUJITSU LIMITED, Kawasaki-shi (JP)

(21) Appl. No.: 13/449,933

(22) Filed: Apr. 18, 2012

(30) Foreign Application Priority Data
Apr. 28, 2011 (JP) 2011-102002

(51) Int. Cl. G11B 23/023

(52) U.S. Cl. 312/9.29

(57) ABSTRACT

A library apparatus includes cartridges each including a first fitting portion formed on a first surface and a second fitting portion formed on a second surface, a storage unit, and a transporting unit including a pulling unit to pull out a first cartridge from the storage unit, a first supporting unit provided under the pulling unit, having a tapered first distal end unit, and to insert the first distal end unit between the first cartridge and a second cartridge positioned under the first cartridge to release the fitting between the first cartridge and the second cartridge, and a second supporting unit provided above the pulling unit, having a tapered second distal end unit and to insert the second distal end unit between the first cartridge and a third cartridge stacked on the first cartridge to release the fitting between the first cartridge and the third cartridge.

### CROSS-REFERENCE TO RELATED APPLICATION

This application is based upon and claims the benefit of priority of the prior Japanese Patent Application No. 2011-102002, filed on Apr. 28, 2011, the entire contents of which are incorporated herein by reference.

### FIELD

The embodiments discussed herein are related to a library apparatus configured to store storage media.

### BACKGROUND

A computer system includes a high-capacity external storage device such as a tape drive or an optical disk drive and a library apparatus configured to store storage media used in the high-capacity external storage device.

A library apparatus of the related art is illustrated in FIG. 1. As illustrated in FIG. 1, a library apparatus 100 includes assemblies (hereinafter, referred to as cabinets) 102 of storage units (hereinafter, referred to as slots) 106 configured to store storage media cartridge (hereinafter, referred to as a cartridge) 101, a plurality of drives 103 configured to perform recording and reproduction of the cartridge 101, and a transporting robot 104 configured to transport the cartridge 101 mounted in a housing 105.

In an example illustrated in FIG. 1, two of the cabinets 102 are arranged on the left and right sides when viewed from a front A of the library apparatus 100 so as to face each other. The plurality of drives 103 are arranged in stuck one on top of another in the back of the library apparatus 100 when viewed from the front A of the library apparatus 100. The transporting robot 104 is arranged at a center of the library apparatus 100. This arrangement is used as a method of mounting a plurality of cartridges 101 and the drives 103 at a high density. Therefore, the transporting robot 104 has a rotating function to allow access to the two cabinets 102 arranged on the left and right and the drives 103. The transporting robot 104 has a function to move in the vertical direction and in the horizontal direction to allow access to the plurality of stacked drives 103 and the respective slot 106 of the cabinet 102.

FIGS. 2A and 2B are explanatory drawings of an example of the cabinet 102 of the related art. FIG. 2A is a perspective view of the cabinet 102, and FIG. 2B is a perspective view of the cabinet 102 viewed from a side. The cabinet 102 includes the plurality of slots 106 arranged vertically and horizontally and each configured to store the cartridge 101. In the example in FIGS. 2A and 2B, the cabinet 102 includes ten of the slots 106 arranged in the vertical direction, and slots 106 above and below are partitioned by a partitioning plate 107. One cartridge 101 is stored in each of the slots 106. The cartridges 101 are stored such that a front unit of the cartridge 101 partly projects from the slot 106 to allow the transporting robot 104 to take out the cartridge 101 using a depression on a side surface thereof. Referring to FIG. 2B, since the thickness of the partitioning plate 107 is preferably about 5 mm, the height of the slot preferable for storing one cartridge is 27 mm, where the thickness of the cartridge 101 is approximately 22 mm. Since the cabinet 102 in FIGS. 2A and 2B has the ten slots in the vertical direction, the height of the cabinet is approximately 270 mm.

Japanese Laid-open Patent Publication No. 10-3727 is an example of related art.

In the library apparatus of the related art as well, two cabinets 102 are placed face to face so as to be capable of storing a large number of the cartridges 101. Data to be treated is increased and hence the capability of storing more cartridges is desired. However, in the cabinet 102 of the related art, when an attempt is made to increase the number of the slots 106 in the height direction in order to increase the number of the cartridges to be stored, the height of the entire cabinet 102 is increased, so that the stability of the cabinet 102 is lowered. In order to store and house the cartridges 101 in the slots 106 at high positions, the size of a vertically movable unit of the transporting robot 104 is also increased. Therefore, it is difficult to increase the number of the slots in the height direction. In contrast, when an attempt is made to increase the number of columns of the slots of the cabinet in the lateral direction, the space for installation of the library apparatus as a whole is increased. The length of a rail configured to make the transporting robot 104 movable may have to be increased. Extension of the cabinet 102 in the vertical direction and the lateral direction is limited. Therefore, increase in number of media to be stored in one cabinet is desired without increasing the size of the cabinet.

### SUMMARY

According to an aspect of the invention, a library apparatus includes a plurality of cartridges, the cartridges each including a first fitting portion formed on a first surface, and a second fitting portion formed on a second surface and configured to fit with a first fitting portion formed on a first surface of other one of the cartridges when being stacked on the other one of the cartridges, a cabinet having a storage unit, the storage unit being configured to store the cartridges in a stacked manner, and a transporting unit configured to transport each of the cartridges, the transporting unit including a pulling unit configured to pull out a first cartridge to be pulled out among the cartridges in a horizontal direction from the storage unit, a first supporting unit provided under the pulling unit, having a tapered first distal end unit, and configured to insert the first distal end unit between the first cartridge and a second cartridge from among the cartridges positioned under the first cartridge to release the fitting between the first cartridge and the second cartridge, and a second supporting unit provided above the pulling unit, having a tapered second distal end unit and configured to insert the second distal end unit between the first cartridge and a third cartridge from among the cartridges stacked on the first cartridge to release the fitting between the first cartridge and the third cartridge.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory drawing of a library apparatus of the related art.

FIGS. 2A and 2B are explanatory drawings of a cabinet of the related art.

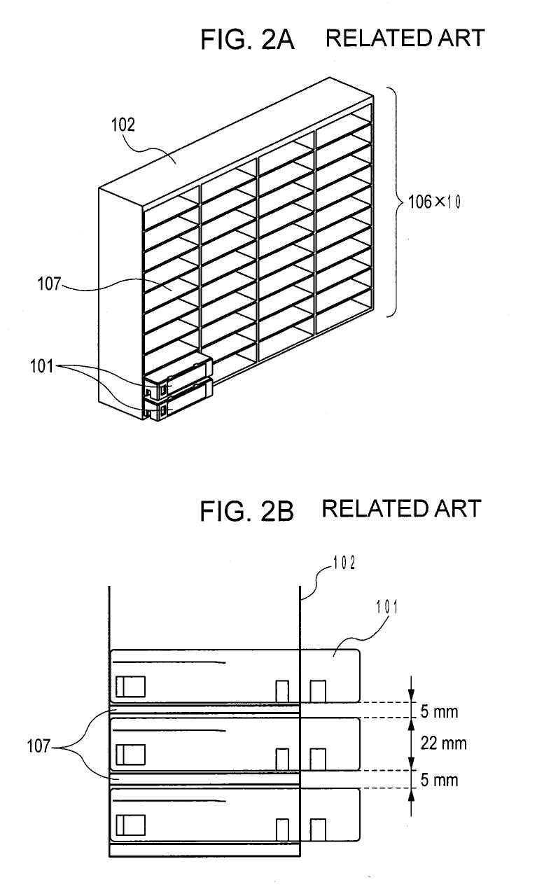

FIGS. 3A and 3B are explanatory drawings illustrating a cartridge structure.

FIGS. 4A to 4C are explanatory drawings illustrating a state in which cartridges are stacked one on top of another.

FIG. 5 is a drawing of a library apparatus according to an embodiment.

FIG. 6 is an explanatory drawing of a cabinet according to this embodiment.

FIGS. 7A and 7B are explanatory drawings illustrating slots according to this embodiment.

FIG. 8 is an explanatory drawing illustrating an action of taking out a cartridge.

FIG. 9 is an explanatory drawing illustrating an action of a transporting robot.

FIGS. 10A and 10B are drawings illustrating a state in which the transporting robot holds the cartridge.

FIGS. 11A and 11B are explanatory drawings illustrating a structure of a picker.

FIG. 12 is an explanatory drawing illustrating the structure of the picker.

FIGS. 13A and 13B are explanatory drawings illustrating a structure of a jack up block.

FIGS. 14A and 14B are plan view of the jack up block.

FIGS. 15A and 15B are explanatory drawings illustrating an action of the jack up block.

FIGS. 16A and 16B are explanatory drawings illustrating an action of a hand to take out the cartridge from the cabinet.

FIG. 17 is an explanatory drawing illustrating the action of the hand to take out the cartridge from the cabinet.

FIGS. 18A to 18C are explanatory drawings illustrating the action of the hand to take out the cartridge from the cabinet.

FIG. 19 is an explanatory drawing illustrating an action of transporting the stored cartridge to a drive.

FIGS. 20A and 20B are enlarged drawings illustrating a unit in the vicinity of a lock block located on the backside of the picker.

FIGS. 21A and 21B are drawings illustrating a state in which the cartridge is inserted into the drive.

FIGS. 22A and 22B are drawings illustrating upward and downward actions of the jack up block.

FIGS. 23A and 23B are explanatory drawings illustrating a relationship between the movement of the picker and the position of a shaft of a slide block.

FIGS. 24A and 24B are explanatory drawings illustrating an action of returning the cartridge taken out from the drive back to the slot.

FIG. 25 is a functional block diagram illustrating the library apparatus.

FIG. 26 is an example flowchart illustrating a procedure of a controller.

FIGS. 27A and 27B are explanatory drawings illustrating a relationship between the cartridges stored in the slots and a medium management table that manages these cartridges.

FIGS. 28A and 28B are explanatory drawings illustrating the relationship between the cartridges stored in the slots and the medium management table that manages these cartridges.

FIGS. 29A and 29B are explanatory drawings illustrating the relationship between the cartridges stored in the slots and the medium management table that manages these cartridges.

### DESCRIPTION OF EMBODIMENT

Referring to the drawings, embodiments of the disclosed technology will be described in detail.

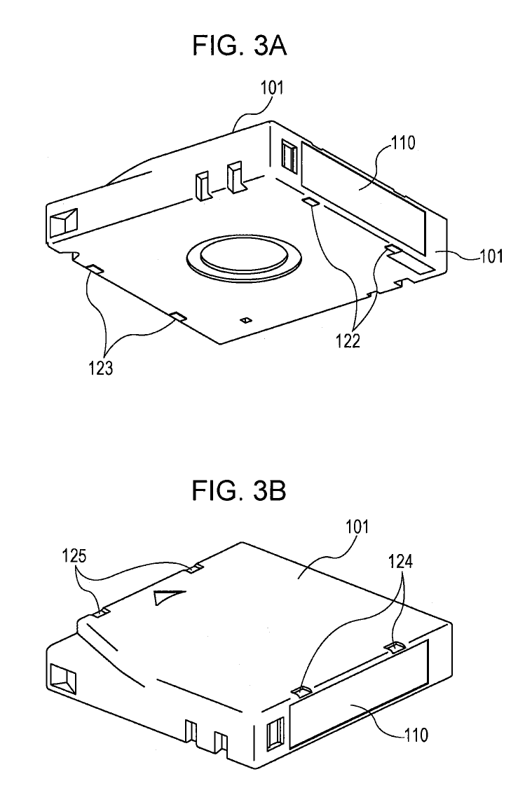

FIGS. 3A and 3B illustrate a structure of a cartridge 101. FIG. 3A is a perspective view of the cartridge 101 viewed from a bottom surface, and FIG. 3B is a perspective view of the cartridge 101 viewed from the top.

Referring to FIG. 3A, a label 110 for managing the cartridge 101 is adhered to a back surface of the cartridge 101. On the bottom surface (corresponding to a second surface in claims) of the cartridge 101, two rear projections 122 (corresponding to a second fitting portion in claims) are formed in a unit close to the label 110 on the back surface and two front projections 123 (corresponding to the second fitting portion in claims) are formed in a unit close to a front surface of the cartridge 101. Referring to FIG. 3B, on the top surface (corresponding to a first surface in claims) of the cartridge 101, two rear depressions 124 (corresponding to a first fitting portion in claims) are formed in a unit close to the label 110 and two front depressions 125 (corresponding to the first fitting portion in claims) are formed in a unit close to the front surface of the cartridge 101.

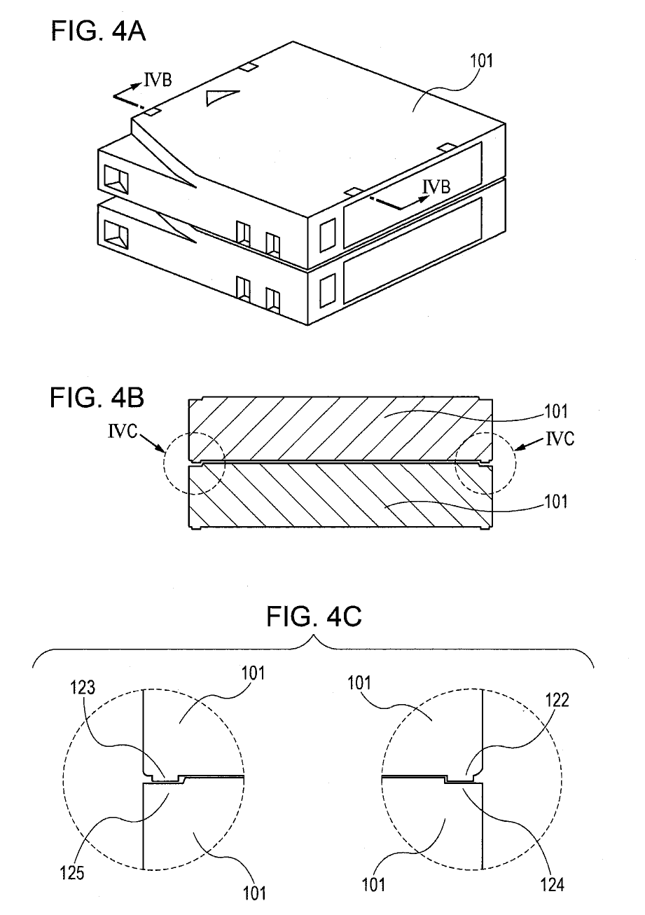

FIGS. 4A to 4C are explanatory drawings illustrating a state in which two of the cartridges 101 are stacked one on top of another. FIG. 4A illustrates a perspective view in a state in which the two cartridges 101 are stacked one on top of another in the same orientation. FIG. 4B illustrates a cross-sectional view taken along a plane IVB-IVB in FIG. 4A. FIG. 4C is enlarged views of parts IVC and IVC in FIG. 4B, illustrating projections on the bottom surface and depressions on an upper surface at the front and the back of the cartridge 101. When the two cartridges 101 are stacked one on top of another, the rear projection 122 formed on the bottom surface of the upper cartridge 101 is fitted into the rear depression 124 formed on the top surface of the lower cartridge 101, and the front projection 123 formed on the bottom surface of the upper cartridge 101 is fitted into the front depression 125 formed on the top surface of the lower cartridge 11, so that the upper and lower cartridges are stacked in tight contact with each other. In this manner, the cartridges 101 are formed with fitting portions (depressions and projections) in advance so as to avoid displacement therebetween even when being stacked one on top of another. In a library apparatus 100 of the related art, if the cartridges 101 are stored in a stacked manner, the cartridge 101 may hardly be taken out by an automatic machine such as a robot due to the presence of the depressions and the projections, and hence partitioning plates 107 are provided and the cartridges 101 are stored in respective slots 106 one by one when storing the cartridges 101 in a cabinet 102.

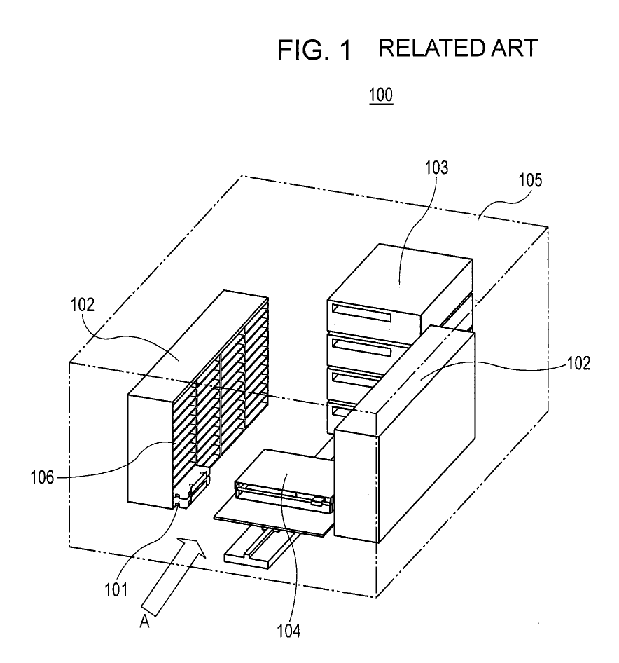

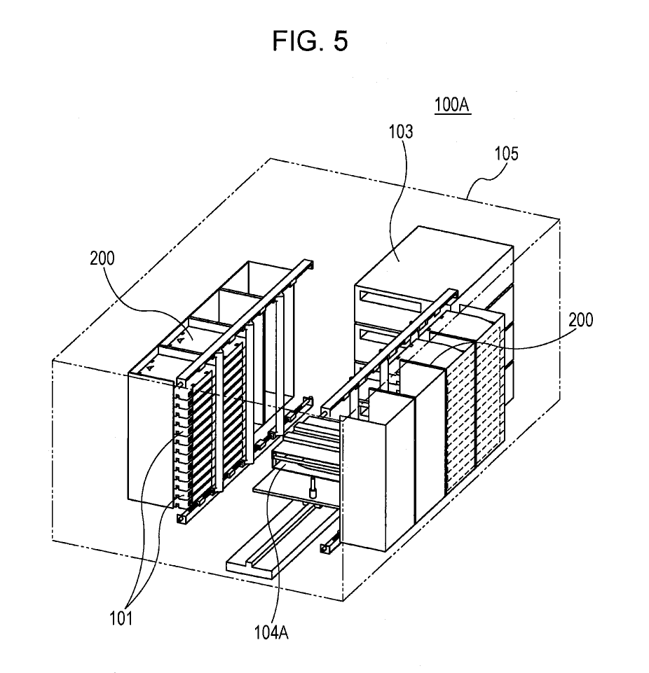

FIG. 5 illustrates a library apparatus 100A according to this embodiment. The library apparatus 100A includes a cabinet 200 configured to store the cartridges 101, a drive 103 configured to perform recording and reproduction of the cartridges 101, and a transporting robot 104A configured to transport the cartridges 101 mounted in a housing 105. The library apparatus 100A according to this embodiment is different from the library apparatus 100 of the related art illustrated in FIG. 1 in the structures of the cabinet 200, and the transporting robot 104A configured to transport the cartridges 101.

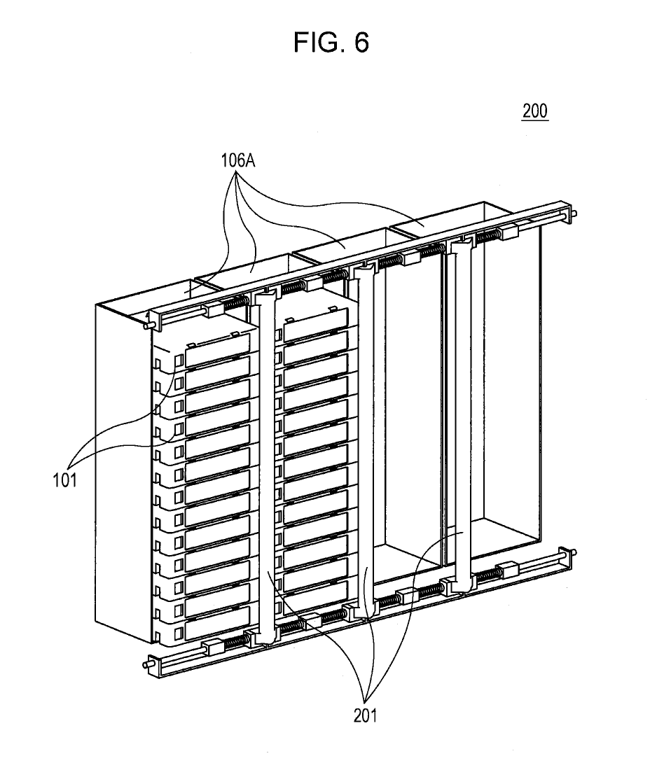

FIG. 6 illustrates the cabinet 200 according to this embodiment. The cabinet 200 according to this embodiment is formed of an assembly of four storage units (hereinafter, referred to as slots) 106A arranged in a line to store the cartridges 101. In each of the slots 106A, the cartridges 101 are stored by being directly stacked one on top of another as illustrated in FIG. 4A. The partitioning plates 107 of the cabinet 102 of the library apparatus 100 of the related art, which are provided to partition the upper and lower cartridges 101 of the slots 106, do not exist. Stoppers 201 are disposed in the vicinities of boundaries between the slots 106A and adjacent slots 106 arranged side by side near entries thereof. The stoppers 201 are configured to prevent the stored cartridges 101 from coming out of the slots 106A.

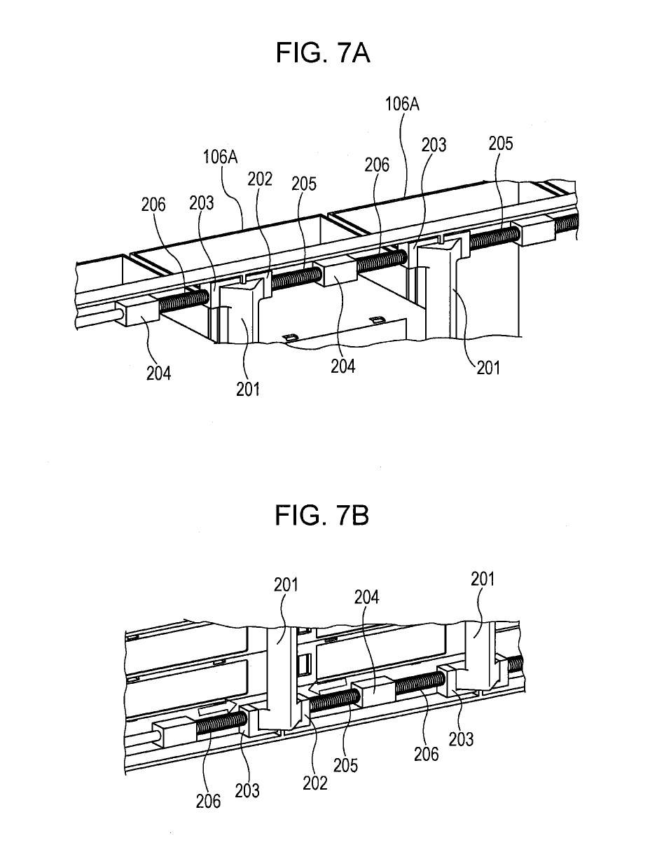

FIGS. 7A and 7B are enlarged drawings of the slots 106A according to this embodiment. FIG. 7A is an enlarged drawing illustrating an area in the vicinity of entries of the cartridges 101 of upper units of the slots 106A, and FIG. 7B is an enlarged drawing illustrating an area in the vicinity of the entries of the cartridges 101 of lower units of the slots 106A. Hereinafter, in order to indicate a relative positional relationship between respective components, reference symbols “L” and “R” are used. The symbol “L” indicates that the corresponding component is positioned on the left side, and the symbol “R” indicates that the corresponding component is positioned on the right side. Referring to FIG. 7A, fixing blocks 204 are fixed at centers of the upper units of the slots 106A. In the same manner, referring to FIG. 7B, the fixing blocks 204 are fixed at centers of the lower units of the slots 106A. Each of the stoppers 201 is supported by a slide block 203L movable leftward and rightward and a slide block 202R movable leftward and rightward from both sides on the upper unit and the lower unit of each of the slot 106A.

The slide blocks 203L support the stoppers 201 by springs 206L provided between the fixing blocks 204 on the left sides thereof in the drawing and the slide blocks 203L themselves from the left side in the drawing. The slide blocks 202R support the stoppers 201 by springs 205R provided between the fixing blocks 204 on the right sides thereof in the drawing and the slide blocks 202R themselves from the right side in the drawing.

In the normal state, resilient forces are balanced out between the springs 206L and the springs 205R, so that the stoppers 201 are supported by the slide blocks 203L and the slide blocks 202R on the both sides thereof, and are positioned in the middles between the slots 106A adjacent to each other. In this state, the stoppers 201 are positioned so as to cover end units of the front surfaces of the cartridges 101 stored in the slots 106A on the both sides thereof. In this state, even when the cabinet 200 is inclined due to some vibrations, both ends of the front surfaces of the cartridges 101 are held by the stoppers 201, so that the probability that the cartridges 101 come out of the cabinet 200 is reduced.

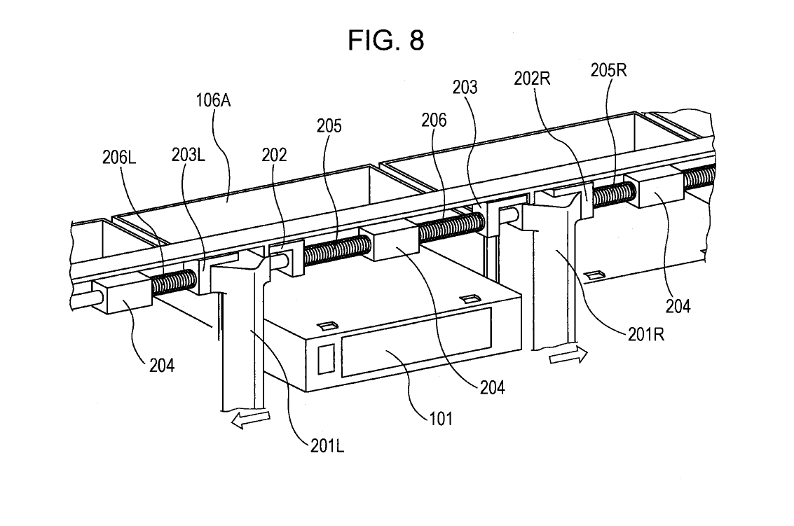

An action of the stoppers 201 when the cartridge 101 is taken out from the slot 106A will be described with reference to FIG. 8. FIG. 8 illustrates a state of the stoppers 201 when the cartridge 101 is taken out from the slot 106A. In order to depict the relationship between the cartridge 101 and the stoppers 201, the transporting robot 104A is not illustrated in FIG. 8. The left stopper 201L and the right stopper 201R located on the left and right of the entry of the slot 106A are moved leftward and rightward respectively from the positions in the normal state by the transporting robot 104A, described later. Consequently, the cartridge 101 is allowed to be pulled out frontward by the transporting robot 104A.

The left stopper 201L moved leftward moves the slide block 203L on the left side thereof leftward in the drawing. Therefore, the spring 206L on the left side is compressed between the left slide block 203L and the fixing block 204. In the same manner, the right stopper 201R moved rightward moves the slide block 202R on the right side thereof rightward in the drawing. Therefore, the spring 205R on the right side thereof is compressed between the slide block 202R and the fixing block 204.

After the cartridge 101 is taken out from the slot 106A, the left stopper 201L and the right stopper 201R located on the left and right of the entry of the slot 106A, which are moved leftward and rightward by the transporting robot 104, are automatically returned to the normal positions. It is because the slide block 203L and the slide block 202R are pushed back by forces of the compressed spring 206L and spring 205R restoring to the original states thereof, and the left stopper 201L and the right stopper 201R are returned back to the original positions thereof.

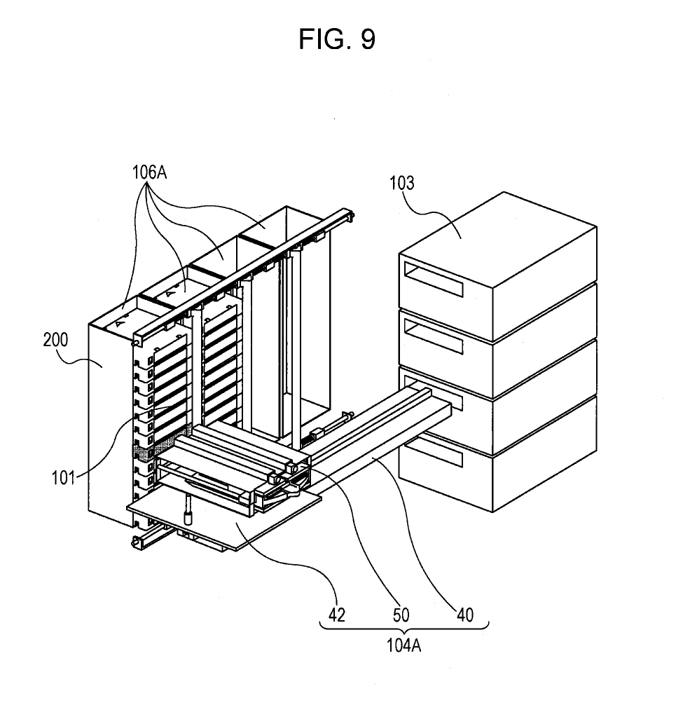

FIG. 9 is an explanatory drawing illustrating an action of the transporting robot 104A in the library apparatus 100A according to this embodiment. The transporting robot 104A includes a rail 40 supported so as to be capable of being moved upward and downward, a base table 42 configured to move on the rail 40, and a hand 50 installed on the base table 42 and configured to hold the cartridge 101. The hand 50 moves on the rail 40, takes out the specified cartridge 101 from the cabinet 200, moves on the rail 40 to a position of the stacked drives, and inserts the cartridge 101 into an insertion port of the specified drives 103 from among the drives. Alternatively, the hand 50 holds the cartridge 101 discharged from the insertion port of the drives 103, and moves on the rail 40 to the cabinet 200 where the cartridge 101 used to be stored, and stores the cartridge 101 in the cabinet 200.

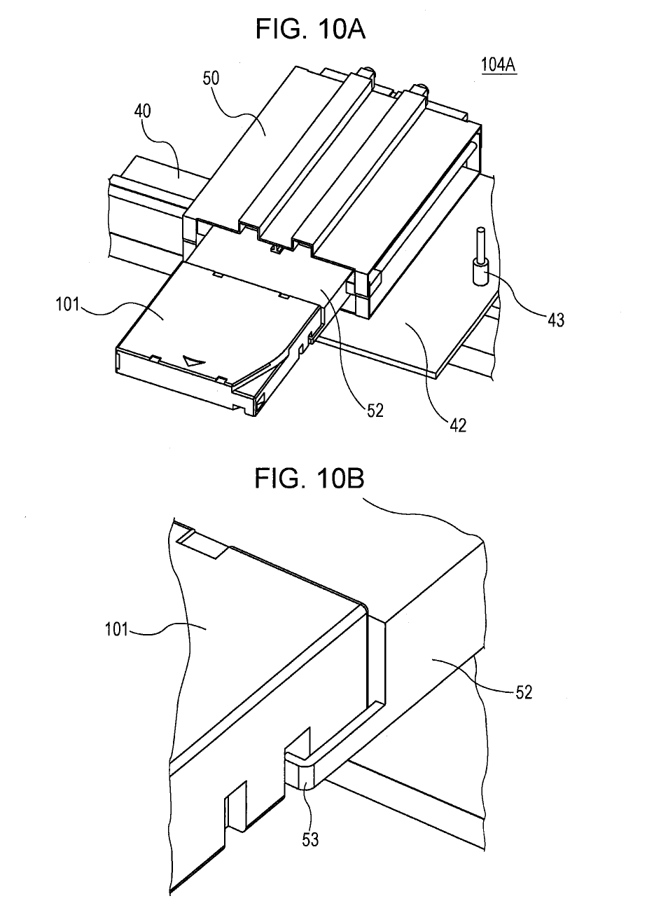

FIG. 10A illustrates a state in which the hand 50 takes out the specified cartridge 101 from the cabinet 200 and holds the cartridge 101. The hand 50 includes a picker 52 integrated therein and moving reciprocally from a side surface of the hand 50 toward the cabinet 200. Here, in order to illustrate the state of the picker 52, an upper jack up block 56 and a lower jack up block 54 described later are not illustrated. FIG. 10B is an enlarged drawing of a distal end unit of the picker 52. The cartridge 101 is held by engagement between a pair of gripping units 53 at distal ends of the picker 52 and depressions on side surfaces of the cartridge 101.

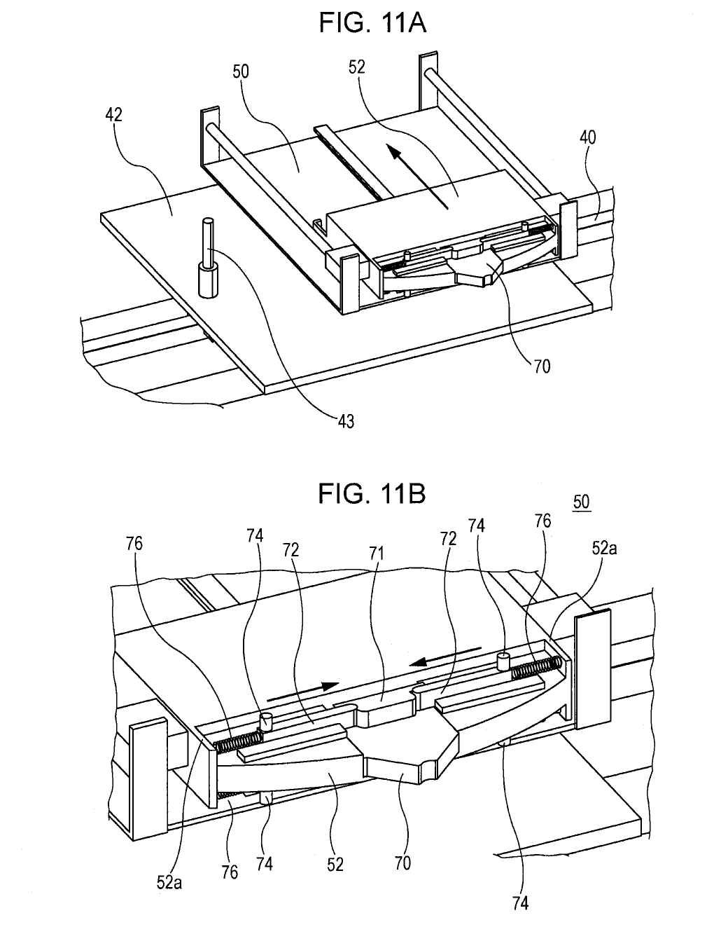

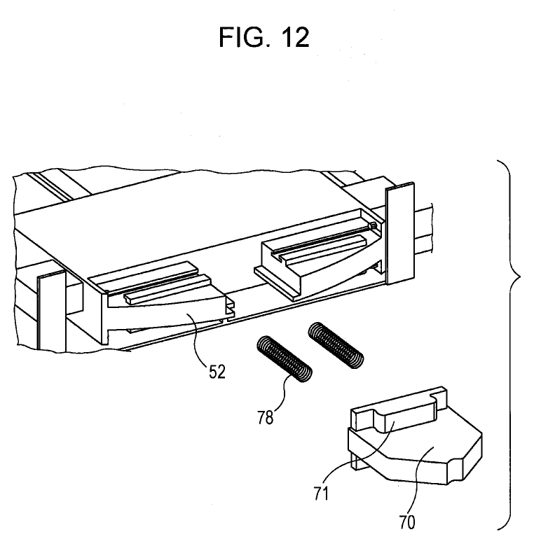

FIGS. 11A, 11B, and FIG. 12 are explanatory drawings illustrating a structure of the picker 52 in the inside of the hand 50. FIG. 11A is a drawing of the inside of the hand 50 viewed from the backside. The picker 52 moves from the inside of the hand 50 forward (the front side of FIG. 10A) as illustrated in FIG. 10A by pushing out a lock block 70 provided on the backside of the picker 52 toward the farther side as indicated by an arrow in FIG. 11A by a drive mechanism, not illustrated.

FIG. 11B is an enlarged drawing of a backside of the picker 52. The lock block 70 is fitted into a center of the picker 52. A shouldered unit 71 on the upper surface of the lock block 70 is supported by slide blocks 72 from the left and right sides. The slide blocks 72 support the shouldered unit 71 on the upper surface of the lock block 70 from left and right sides while applying forces in the direction indicated by arrows in FIG. 11B by springs 76 placed between end units 52a of the picker 52 and compressed therebetween. In the vicinities of the springs 76 of the slide blocks 72, there are shafts 74 projecting upward of the picker 52. The shafts 74 control an action of the upper jack up block 56 arranged above the picker 52 and described later. The similar shouldered unit 71 is formed on a lower surface of the lock block 70, and is supported by the slide blocks 72 from the left and right sides in the same manner. The slide blocks 72 on the lower side of the lock block 70 includes the shafts 74 projecting downward of the picker 52. The shafts 74 control an action of the lower jack up block 54 arranged under the picker 52 and described later.

FIG. 12 is an explanatory drawing illustrating a structure of the lock block 70. The lock block 70 is fitted with springs 78 placed in a depression at the center of the picker 52 so as to be clamped therebetween. With the springs 78, the position of the lock block 70 is shifted forward and backward with respect to the picker 52. When the position of the lock block 70 is changed, the positions of the slide blocks 72 which support the shouldered unit 71 from the left and right sides is changed correspondingly.

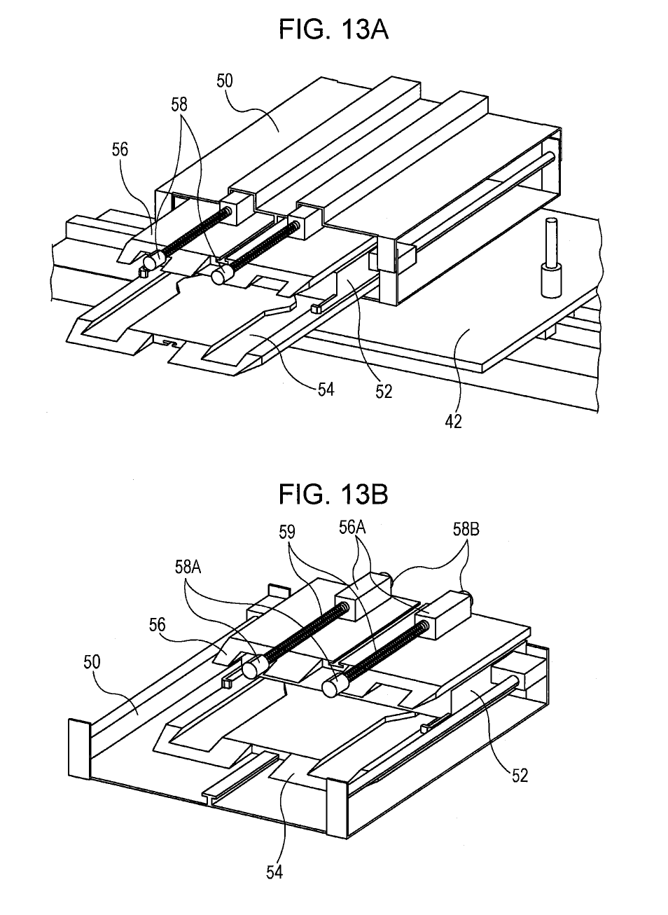

FIGS. 13A and 13B are explanatory drawings illustrating structures of the upper jack up block 56 (corresponding to a second supporting unit in claims) and the lower jack up block 54 (corresponding to a first supporting unit in claims) arranged above and below the picker 52. Referring to FIG. 13A, the hand 50 includes the lower jack up block 54 moving reciprocally from the lower side of the picker 52 integrated therein. A distal end of the lower jack up block 54 is formed into a shape gradually decreasing in thickness (a tapered shape) and, although described later, is formed into a shape desirable when inserting the lower jack up block 54 between the cartridge 101 and the cartridge 101 stacked one on top of another. The hand 50 includes the upper jack up block 56 moving reciprocally from the upper side of the picker 52 integrated therein. A distal end of the upper jack up block 56 is formed into a shape gradually decreasing in thickness (a tapered shape) and, although described later, is formed into a shape desirable when inserting the upper jack up block 56 between the cartridge 101 and the cartridge 101 stacked one on top of another. The hand 50 includes a pair of pushers 58 integrated in the hand 50 and moving reciprocally from the upper side of the upper jack up block 56.

FIG. 13B is a drawing illustrating a state in which an upper cover of the hand 50 is removed for explaining the structure of the pushers 58. Referring to FIG. 13B, both of the end units 58A and 58B of the pushers 58 are thicker in diameter than a body unit, and the body units of the pushers 58 penetrate through the inside of two pusher fixing units 56A provided on the jack up block 56. Springs 59 are wound on the body units of the pushers 58 in a compressed manner, and when one of the distal end units 58A is pressed toward the pusher fixing units 56A, forces to restore the original states act thereon.

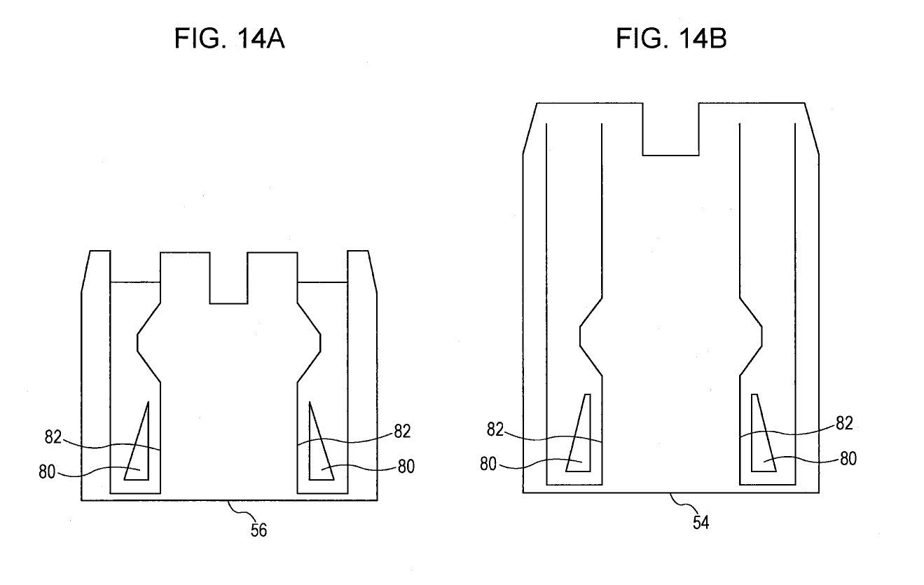

FIGS. 14A and 14B are plan views of the upper jack up block 56 and the lower jack up block 54. Each of the lower jack up block 54 and the upper jack up block 56 has a structure of being mounted on rails of the frame of the hand 50 and being capable of sliding to the outside of the hand 50 together with the picker 52. The upper jack up block 56 is shorter than the lower jack up block 54. FIG. 14A is a plan view of the upper jack up block 56 viewing a lower surface (the picker 52 side) thereof. The lower surface of the upper jack up block 56 is formed with two projections 80 having a triangular shape in plan view. Cam grooves 82 are formed in the inside of the projections 80 respectively. The projections 80 have a function to cause the upper jack up block 56 and the picker 52 to act together as described later. FIG. 14B is a plan view of the lower jack up block 54 viewing an upper surface (the picker 52 side) thereof. The upper surface of the upper jack up block 54 also is formed with the two projections 80 having a triangular shape in plan view. Inside of the projections 80 are formed with the cam grooves 82, respectively. The projections 80 have a function to cause the lower jack up block 54 and the picker 52 to act together as described later.

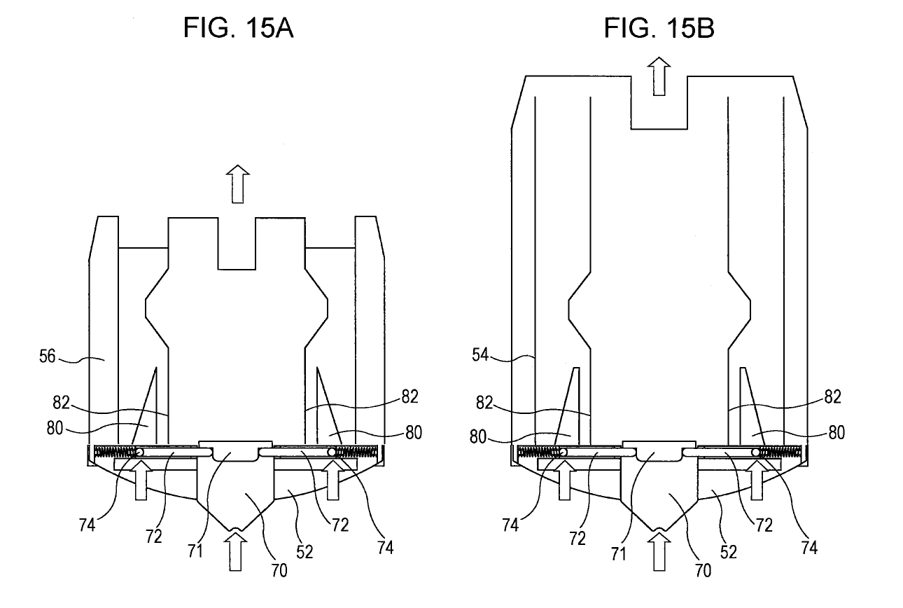

FIGS. 15A and 15B are explanatory drawings illustrating the actions of the upper jack up block 56 and the lower jack up block 54. The actions of the upper jack up block 56 and the lower jack up block 54 relate to the positions of the projections 80 and the shafts 74 of the slide blocks 72 on the backside of the picker 52. As illustrated in FIG. 11B, the actions of the upper jack up block 56 and the lower jack up block 54, in a state in which the shouldered unit 71 on the upper surface of the lock block 70 on the backside of the picker 52 is supported by the slide blocks 72 from the left and right sides, will be described below.

Referring to FIG. 15A, the shafts 74 projecting upward of the picker 52 from the slide blocks 72 come into contact with the projections 80 on the lower surface of the upper jack up block 56. In this state, when the lock block 70 is pressed downward in the direction indicated by arrows in FIG. 15A by a drive mechanism, not illustrated, the projections 80 are pressed by the shafts 74, and the upper jack up block 56 moves in the direction indicated by the arrows together with the picker 52.

Referring to FIG. 15B, the shafts 74 projecting downward of the picker 52 from the slide blocks 72 come into contact with the projections 80 on the upper surface of the lower jack up block 54. In this state, when the lock block 70 is pressed downward in the direction indicated by arrows in FIG. 15B by a drive mechanism, not illustrated, the projections 80 are pressed by the shafts 74, and the lower jack up block 54 moves in the direction indicated by the arrows together with the picker 52. In this manner, the upper jack up block 56 and the lower jack up block 54 move simultaneously together with the picker 52.

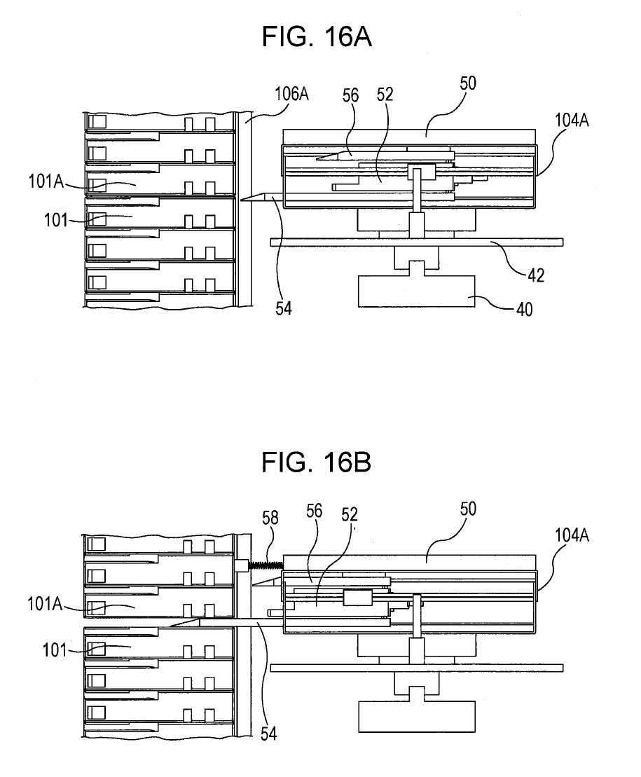

FIG. 16A to FIG. 18B are explanatory drawing illustrating an action of the hand 50 taking out the cartridge 101 from the cabinet 200. As illustrated in FIG. 16A, the transporting robot 104A is positioned in front of a cartridge 101A which is requested from a host with respect to the cartridges 101 stacked in the cabinet 200. Subsequently, the picker 52 and the lower jack up block 54 and the upper jack up block 56 moving in conjunction with the picker 52 are moved forward with respect to the cartridge 101A. At this time, if the position of the transporting robot 104A is shifted in the vertical direction with respect to the cartridge 101, the distal end of the lower jack up block 54 abuts against the back surface of the cartridge 101 (the surface viewed from the near side of the slot 106A).

Subsequently, referring to FIG. 16B, at this time, the hand 50 moves the transporting robot 104A in its entirety in the vertical direction while applying a force to move forward. When the lower jack up block 54 comes to a boundary between the specified cartridge 101A and the cartridge 101 located right below, the distal end of the tapered shape of the lower jack up block 54 enters a gap therebetween while lifting the specified cartridge 101A upward. When the lower jack up block 54 is moved further forward, a front unit of the specified cartridge 101A rides on the lower jack up block 54, and fitting between the rear projections 122 on the bottom surface of the specified cartridge 101A and the rear depressions 124 on the upper surface of the cartridge 101 right under the specified cartridge 101A is released. Simultaneously, the pusher 58 is moved forward together with the upper jack up block 56, and a distal end of the pusher 58 abuts against the back surface of the cartridge 101 right above the specified cartridge 101A and supports the cartridge 101.

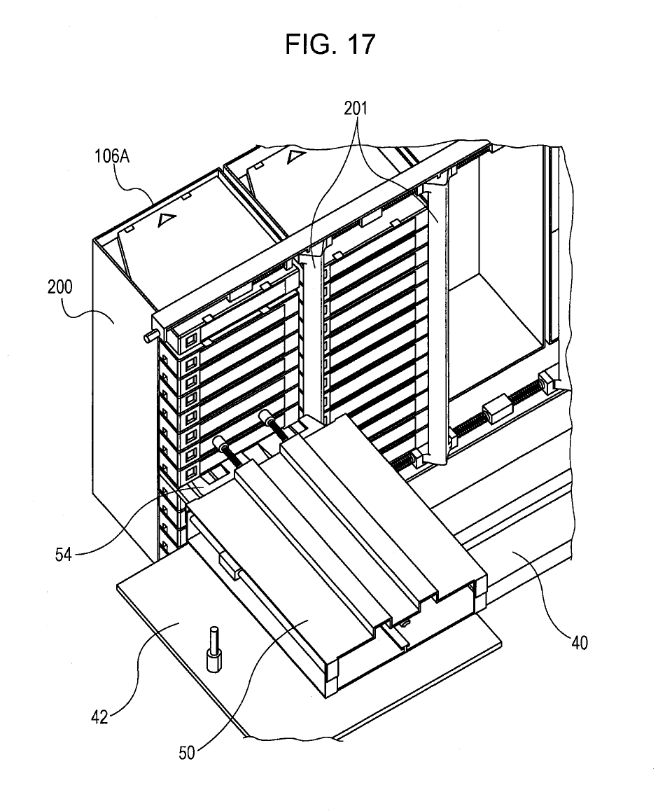

Referring to FIG. 17, at this time, the lower jack up block 54 moves the stoppers 201 on both sides of the slot 106A of the cabinet 200 outward. Since FIG. 17 illustrates a case where the cartridge 101 in the leftmost slot 106A of the cabinet 200 is taken out, there is no stopper on the left side of the slot 106A. The lower jack up block 54 moves only the stopper 201 on the right side of the slot 106A rightward. At this time, the stopper 201 is released for all the cartridges 101 stacked in the slot 106A. Even when the specified cartridge 101A and the cartridge 101 just above the cartridge 101A are lifted up by the lower jack up block 54 and an unstable state is assumed, since the pusher 58 supports the front surface of the cartridge 101 just above the specified cartridge 101A, the cartridges 101 do not come out from the slot 106A. Accordingly, the specified cartridge 101A may be pulled out from the slot 106A.

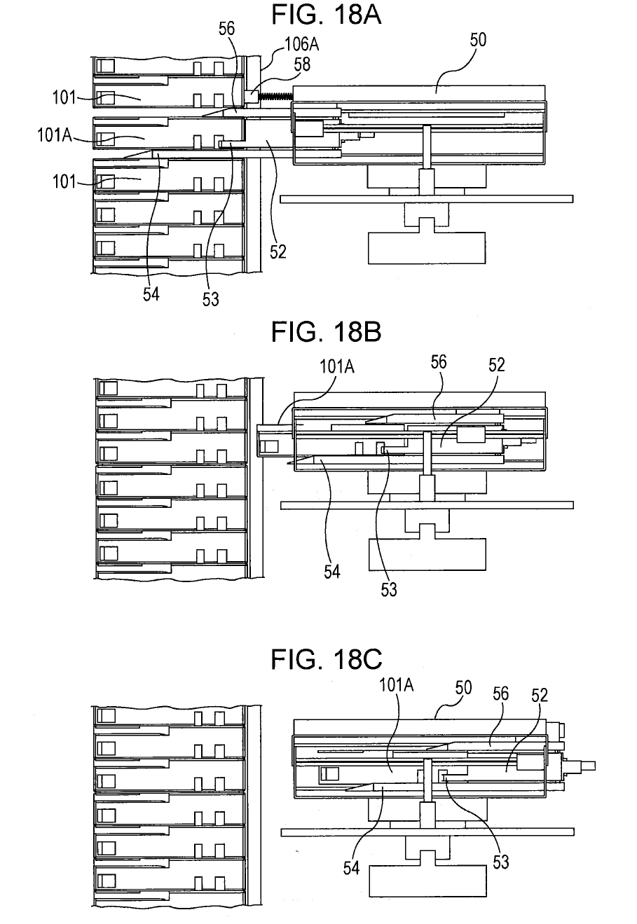

Referring to FIG. 18A, the picker 52, the lower jack up block 54, and the upper jack up block 56 are simultaneously moved further forward with respect to the cartridge 101. The lower jack up block 54 moves forward to the back of the slot 106A. Therefore, the specified cartridge 101A is brought into a state of completely riding on the lower jack up block 54. Accordingly, the front projection 123 on a bottom surface of the specified cartridge 101A is also brought into a state of being lifted upward from the front depression 125 on the upper surface of the cartridge 101 right under the specified cartridge 101A, and hence the fitting is released.

The distal end of the taper shape of the upper jack up block 56 enters a boundary between the specified cartridge 101A and the cartridge 101 just above the specified cartridge 101A, is moved forward, and lifts the cartridge 101 just above the specified cartridge 101A upward. Accordingly, fitting between the rear projections 122 on the bottom surface of the cartridge 101 right above the specified cartridge 101A and the front depressions 125 on the upper surface of the specified cartridge 101A is also released. Consequently, the specified cartridge 101A is released from being fitted with the upper and lower cartridges 101. Simultaneously, the gripping units 53 at the distal ends of the picker 52 are fitted to depressions on side surfaces of the specified cartridge 101A, so that the specified cartridge 101 is allowed to be pulled out.

Subsequently, referring to FIG. 18B, the picker 52 is retracted in a state in which the specified cartridge 101A is caught. Since the front projection 123 on the bottom surface of the cartridge 101 right above the specified cartridge 101A may be pulled rearward when viewed from the specified cartridge 101A, the specified cartridge 101A may be pulled out as is. At this time, the lower jack up block 54 and the upper jack up block 56 are also retracted together. The specified cartridge 101A is supported on the bottom surface thereof by the lower jack up block 54, and is pulled out from the slot 106A in a state in which the front unit of the upper surface is supported by the upper jack up block 56. In an initial stage of the pulling out action, the pusher 58 is in a state in which the pusher 58 pushes the back surface of the cartridge 101 right above the specified cartridge 101A inward. Therefore, the cartridges 101 located above the upper jack up block 56 are not pulled out together. When the pulling-out action is proceeded, the pusher 58 is also retracted together with the picker 52, and leaves the front surface of the cartridge 101 right above the specified cartridge 101A. When the specified cartridge 101A is completely pulled out, the cartridges 101 located above the specified cartridge 101A fall down all at once. In this case, the stopper 201 is also closed, and hence the cartridges 101 do not fall out from the slot 106A.

FIG. 18C illustrates a state in which the specified cartridge 101A is completely stored in the hand 50. In this state, the cartridge 101A is then transported to the drive 103. At this time, the fact that the cartridge 101A is pulled out causes a management table that manages the positions of the cartridges stored in the cabinet 200 to be rewritten.

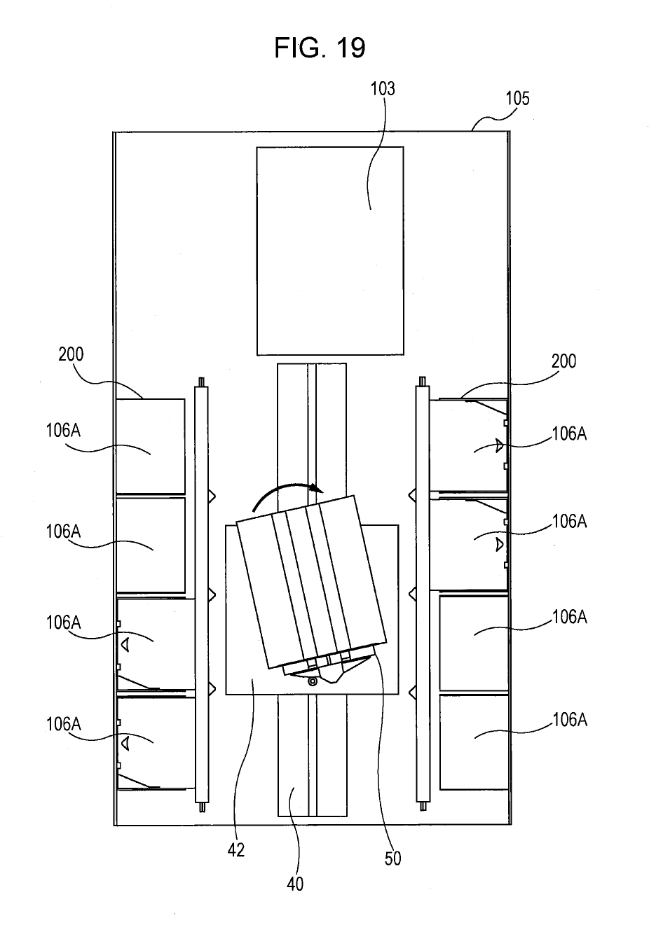

FIG. 19 is an explanatory drawing illustrating an action of transporting the stored cartridge 101A to the drive 103. An insertion port of the hand 50 for the cartridge 101A is rotated by 90° toward the drive 103.

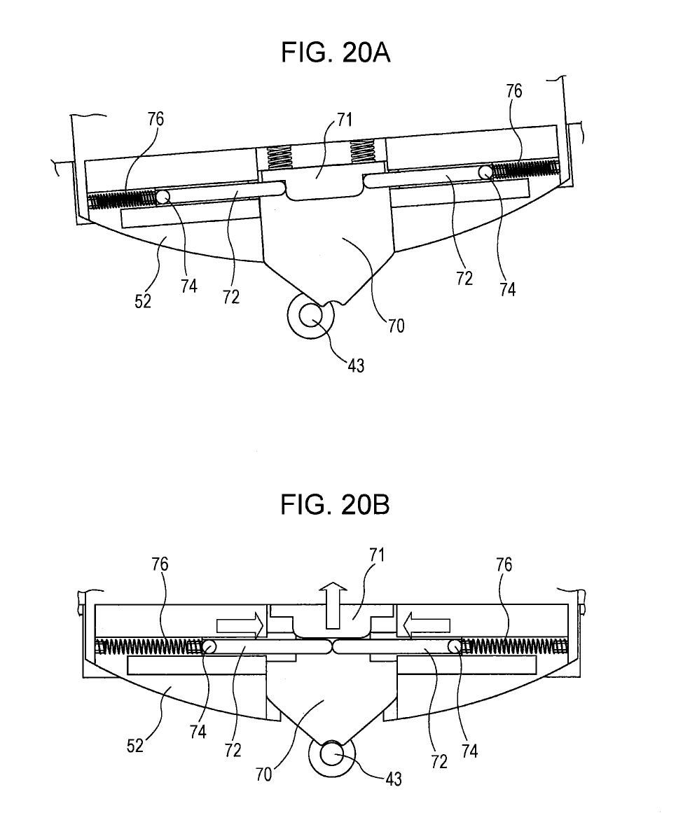

FIGS. 20A and 20B are enlarged drawings of an area in the periphery of the lock block 70 located on the backside of the picker 52 when the insertion port of the hand 50 for the cartridge 101A is rotated to the side of the drives 103. When the insertion port of the hand 50 for the cartridge 101A is rotated to the side of the drives 103 as illustrated in FIG. 20A, the lock block 70 on the backside of the picker 52 abuts against a shaft 43 provided on the base table 42. In this state, the shouldered unit 71 on the upper surface of the lock block 70 is supported by the slide block 72 from the left and right sides.

As illustrated in FIG. 20B, the hand 50 is further rotated toward the front of the insertion port for the cartridge 101A, the shaft 43 is stored in a depression of the lock block 70, and the shafts 43 is brought into a state of continuously pressing the lock block 70. The shouldered unit 71 on the upper surface of the lock block 70 is pushed out through a unit between the left and right slide blocks 72, and the left and right slide blocks 72 are pushed by the springs 76 so that the left and right slide blocks 72 come into direct contact with each other. Therefore, the positions of the shafts 74 of the left and right slide blocks 72 are moved toward a unit near the center.

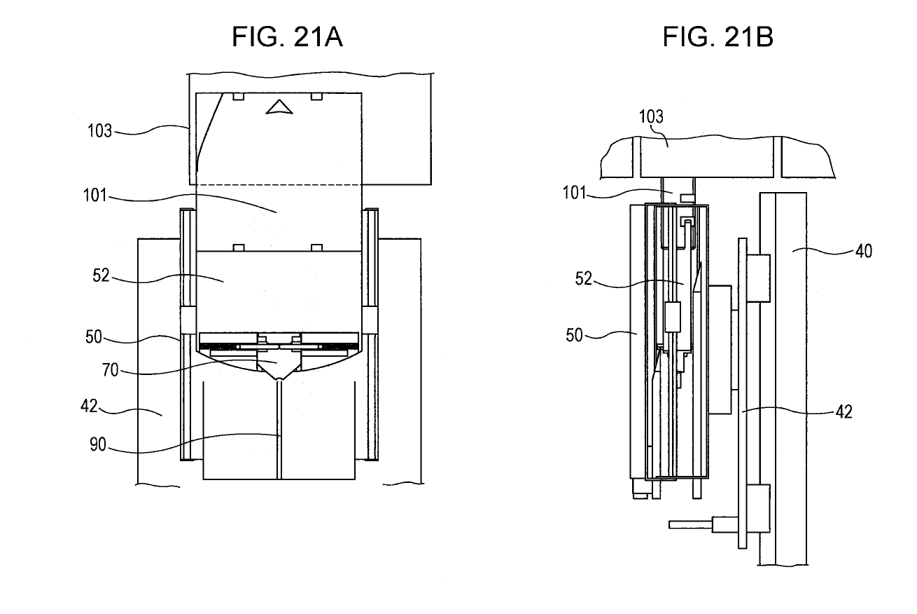

FIGS. 21A and 21B are drawings illustrating a state in which the cartridge 101 is inserted from the hand 50 into the drive 103. FIG. 21A is a perspective view of the drive 103 and the hand 50 viewed from above, and FIG. 21B is a perspective view of the drive 103 and the hand 50 viewed from the side. When a driving mechanism 90 pushes out the lock block 70 on the backside of the picker 52 toward the drive 103, the picker 52 alone projects out from the hand 50 and inserts the supporting cartridge 101 into the drive 103. At this time, the upper jack up block 56 and the lower jack up block 54 stay in the hand 50.

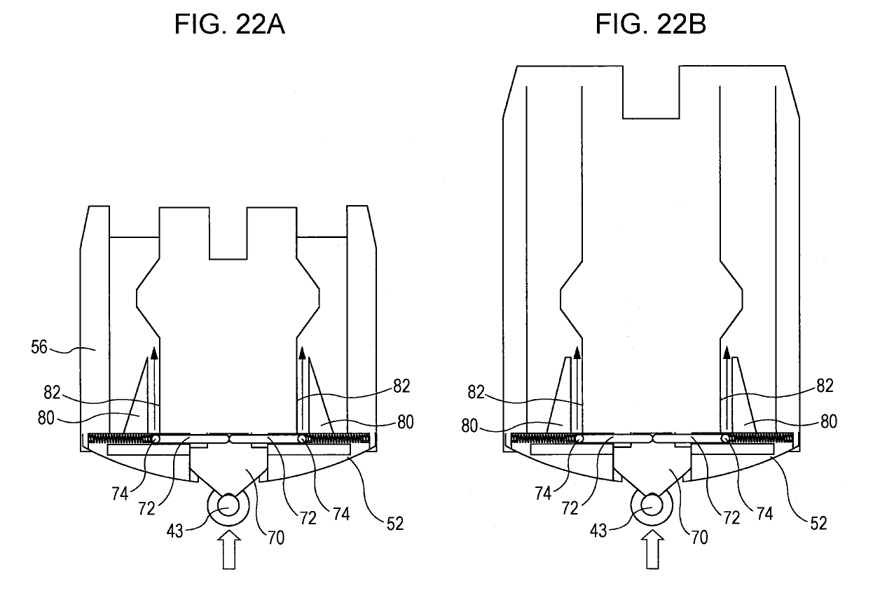

FIGS. 22A and 22B are explanatory drawing illustrating the actions of the upper jack up block 56 and the lower jack up block 54 when the lock block 70 and the left and right slide blocks 72 are brought into a state in FIG. 20B.

Referring to FIG. 22A, the shafts 74 projecting upward of the picker 52 from the slide blocks 72 are located at positions of the cam grooves 82 of the upper jack up block 56. In this state, the lock block 70 is pressed downward in the direction indicated by arrows in FIG. 22A by a drive mechanism, not illustrated, to cause the picker 52 to move forward. At this time, the shafts 74 of the slide blocks 72 pass through the side of the projections 80, and move along the cam grooves 82. Therefore, the upper jack up block 56 stays without moving even when the picker 52 is moved forward.

Referring to FIG. 22B, the shafts 74 projecting downward of the picker 52 from the slide blocks 72 are located at positions of the cam grooves 82 of the lower jack up block 54. In this state, the lock block 70 is pressed downward in the direction indicated by arrows in FIG. 22B by a drive mechanism, not illustrated, to cause the picker 52 to move forward. At this time, the shafts 74 of the slide blocks 72 pass through the side of the projections 80, and move along the cam grooves 82. Therefore, the lower jack up block 56 stays without moving even when the picker 52 is moved forward. Accordingly, only the picker 52 moves forward.

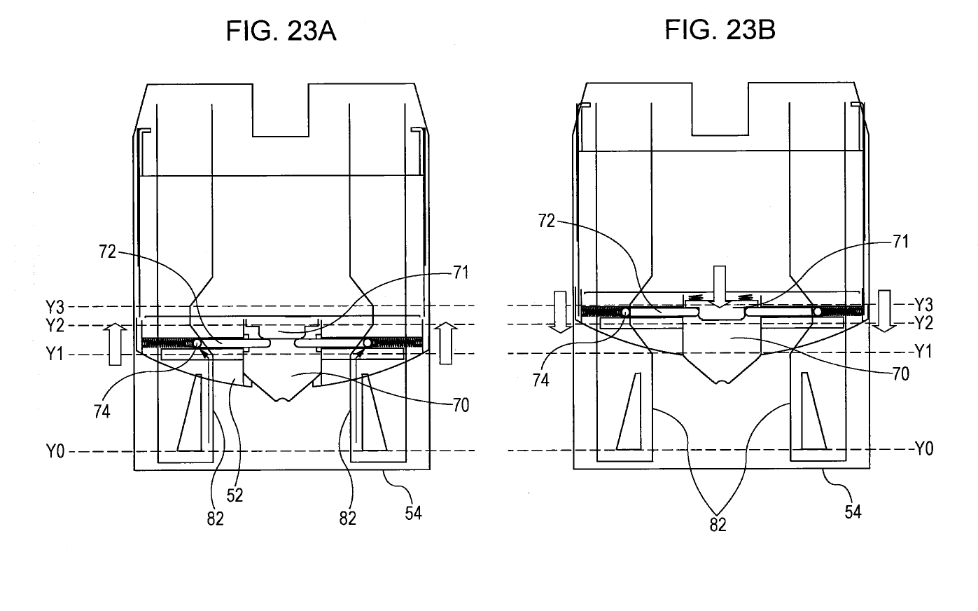

FIGS. 23A and 23B are explanatory drawings illustrating the relationship between the movement of the picker 52 and the positions of the shafts 74 of the slide blocks 72. Referring to FIG. 23A, the picker 52 is moved forward in order to insert the cartridge 101 into the drive 103. As described above, the lower jack up block 54 does not move and stays in the hand 50. The shafts 74 of the slide blocks 72 move forward in the perpendicular direction of FIGS. 23A and 23B from the position of Y0 along the cam grooves 82 formed on the lower jack up block 54. The cam grooves 82 extend outward in a segment from Y1 to Y2. When the picker 52 is moved forward and reaches the position Y1, the left and right slide blocks 72 move outward, and the distance between the left and right slide blocks 72 becomes gradually wider. When the shafts 74 are in a segment from Y2 to Y3, the distance between the left and right slide blocks 72 becomes wider than the width of the shouldered unit 71 of the lock block 70.

After the insertion of the cartridge 101 into the drive 103, the picker 52 is in turn returned back to the original position thereof. Referring to FIG. 23B, the picker 52 is retracted when the shafts 74 are in a segment from Y3 to Y2, and the shouldered unit 71 of the lock block 70 is fitted between the left and right slide blocks 72. When the picker 52 is further retracted, the distance between the left and right slide blocks 72 is reduced as the shafts 74 are moved in a segment from Y2 to Y1, and the shouldered unit 71 is brought into a state of being supported by the left and right slide blocks 72. When the picker 52 is returned back to the original position thereof, the state between the shafts 74 and the lock block 70 is restored to its initial state, as illustrated in FIG. 15B.

When the picker 52 is further retracted, the lock block 70 abuts against the shaft 43, and is pushed forward and inward. Therefore, as illustrated in FIG. 20B, the shouldered unit 71 is returned to a state of being pushed out from between the left and right slide blocks 72. In this state, the picker 52 is moved to take the cartridge 101 placed on the drive 103. At this time as well, the upper and lower jack up blocks are waiting without moving, so that only the picker 52 may be moved forward to take out the cartridge 101 from the drive 103. When the cartridge 101 is pulled out from the drive 103 and the picker 52 is completely retracted, the depression of the lock block 70 is pushed by the shaft 43 inward, so that the position of the slide blocks 72 is returned again to the position illustrated in FIG. 20B. Subsequently, the hand 50 is rotated toward the cabinet 200 in order to return the cartridge 101 into the slot 106A.

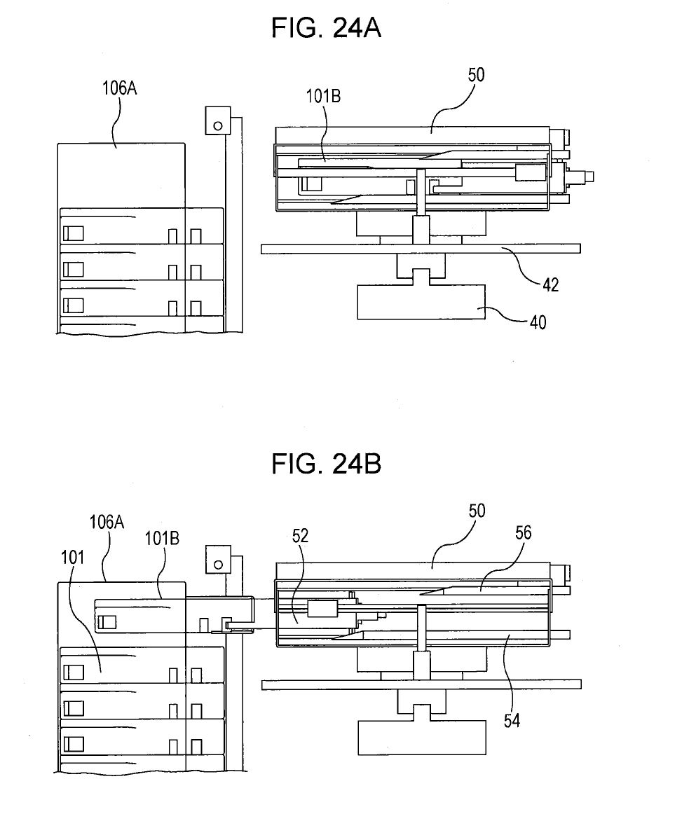

FIGS. 24A and 24B are explanatory drawings illustrating an action of returning a cartridge 101B taken out from the drive 103 to the slot 106A. The cartridge 101B is returned back onto the uppermost cartridge 101 in the slot 106A where the cartridge 101B used to be stored at the beginning. Referring to FIG. 24A, the hand 50 is positioned right above the slot 106A. Then, as illustrated in FIG. 24B, the picker 52 is moved forward in order to put the cartridge 101B into the slot 106A. The stoppers 201 on the left and right sides of the slot 106A are slid leftward and rightward by the cartridge 101B.

At this time, since the positions of the slide blocks 72 and the lock block 70 are still in the state illustrated in FIG. 20B, the upper jack up block 56 and the lower jack up block 54 do not move together, and only the picker 52 pushes out the cartridge 101B and puts the cartridge 101B onto the cartridge 101 in the slot right above the slot 106A. When the cartridge 101B is returned back to the slot 106A, the library information that manages the cartridge 101 stored in the cabinet 200 are rewritten.

After the placement of the cartridge 101B, the picker 52 is retracted. The actions of the slide blocks 72 and the lock block 70 at this time are the same as the actions described with reference to FIGS. 23A and 23B, and the shafts 74 and the lock block 70 are brought into the initial state illustrated in FIG. 15B. Therefore, when an attempt is made to take out the next cartridge 101 from the slot 106A, the upper jack up block 56 and the lower jack up block 54 also move forward together with the picker 52. In this manner, by repeating a series of actions, the cartridges 101 stacked in the slot 106A one on top of another may be gripped and transported to the drives 103, and the cartridges 101 taken out from the drives 103 may be returned into the slot 106A again.

As described above, according to the library apparatus disclosed herein, the mechanism configured to release the fitting between the depressions and projections provided on the upper and lower surfaces of the stacked cartridges is provided on the cartridge transporting robot, so that an intended cartridge may be taken out from the stacked cartridges. Accordingly, the partitioning plates provided in the cabinet of the related art may be omitted, so that the structure of the cabinet may be simplified. Alternatively, since the spaces used for the partitioning plates may be omitted, the more number of cartridges may be stored correspondingly. For example, the cabinet of the related art allows storage of only 10 cartridges in the height direction, while the cabinet according to this embodiment having a height of 270 mm may store 270 mm/22 mm (thickness of the cartridge), that is, twelve cartridges. Therefore, improvement in the storage efficiency of approximately 20% is achieved.

A method of managing the cartridges 101 stored in the cabinet 200 will be described.

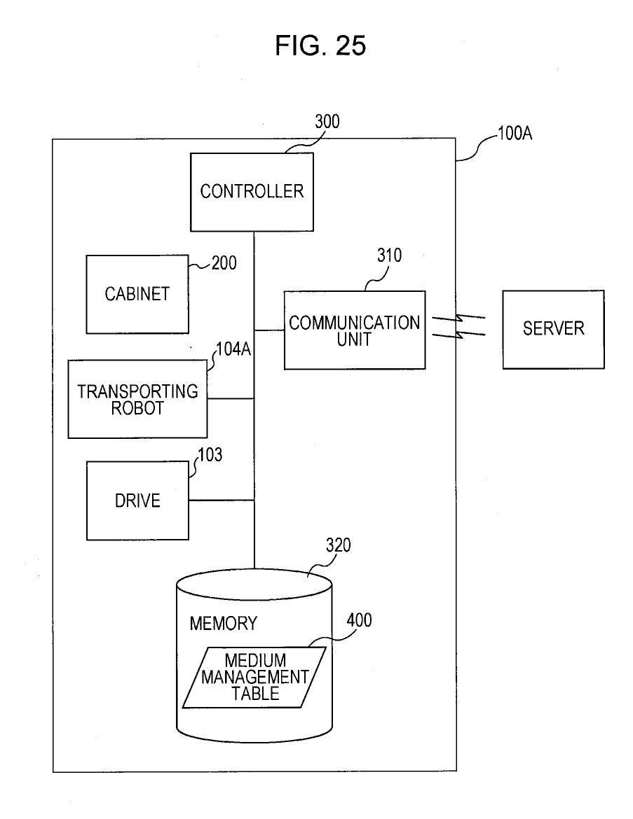

FIG. 25 is a functional block diagram illustrating the library apparatus 100A according to this embodiment. The library apparatus 100A includes a controller 300, a communication unit 310, the cabinet 200, the transporting robot 104A, the drive 103, and a memory 320. In the memory 320, a medium management table 400 configured to manage cartridges stored in slots is recorded. When the library apparatus 100A receives a command from a server via the communication unit 310, the controller 30 analyzes the command and controls the transporting robot 104A.

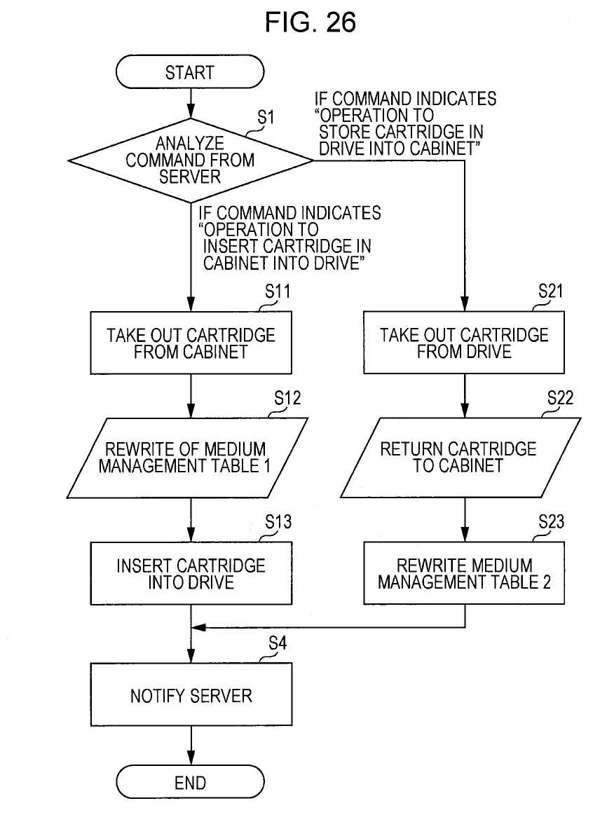

FIG. 26 is an example flowchart illustrating a procedure of controlling the transporting robot 104 by the controller 300. The procedure includes an action of rewriting the medium management table 400 in the memory 320 by the controller 300. When receiving the command from the server via the communication unit 310, the controller 300 analyzes whether the command indicates “an operation to insert a cartridge in the cabinet into the drive” or “an operation to store the cartridge in the drive into the cabinet” in Step S1.

If the command indicates “the operation to insert a cartridge in the cabinet into the drive”, the controller 300 then controls the transporting robot 104A in Step S11 to take out the cartridge 101 specified by the server from the cabinet 200. In this case, the controller 300 rewrites the medium management table 400 recorded in the memory 320 in Step S12.

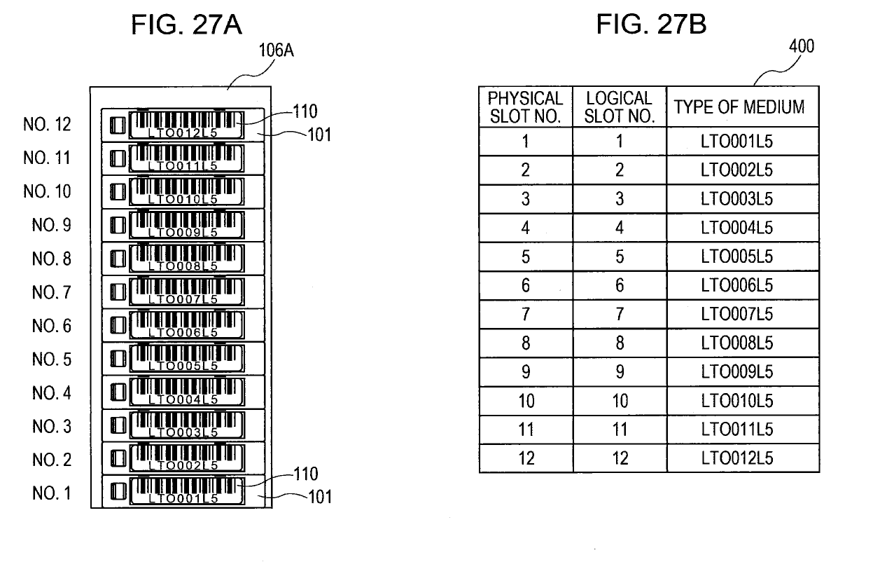

FIGS. 27A and 27B illustrate a state of the cartridge 101 stored in the slot 106A in the initial state, and the medium management table 400 for managing the state.

FIG. 27A illustrates a state in which the cartridges 101 are stored in the slots 106A viewed from the front of the slot 106A. The cartridges 101 are each stored with an insertion port with respect to the drive 103 faced toward the back side, and labels 110 are adhered to on the back surfaces of the cartridges 101. The labels 110 each indicate a number for the management of the corresponding cartridge 101 and a barcode corresponding thereto. The barcodes on the label 110 are read by a reading apparatus provided in the library apparatus, and a desired cartridge 101 may be searched for. The labels 110 are adhered to positions visible from the front of the slot 106A. Numbers from “No. 1” to “No. 12” in sequence from the bottom to the top on the left side of the slot 106A are numbers indicated for explanation, which represent slot numbers.

FIG. 27B illustrates the medium management table 400 configured to manage media (cartridges) recorded in the memory 320 in the library apparatus 100A. In the medium management table 400, types of media (here, barcode label numbers), and individual logical slot numbers attached to the respective media are memorized. The logical slot numbers are numbers presented from the server side to backup software that manages the library apparatus. The library apparatus are not capable of changing the slot numbers and the types of the media on its own.

When the cartridges 101 are stored in the slots 106A, physical slot numbers are recorded in the medium management table 400. The physical slot numbers indicate actual positions of the slots (the slot numbers) and, in this embodiment, the cartridges 101 are stored in a stacked manner, the position of the lowermost cartridge 101 is designated as “1” and numbers are assigned upward in sequence. FIGS. 27A and 27B illustrate the state in the slot 106A in the initial state and contents of the medium management table 400. In the initial state, the physical slot numbers match the logical slot numbers. The library apparatus notifies only the logical slot number and the types of media to the backup software on the server side.

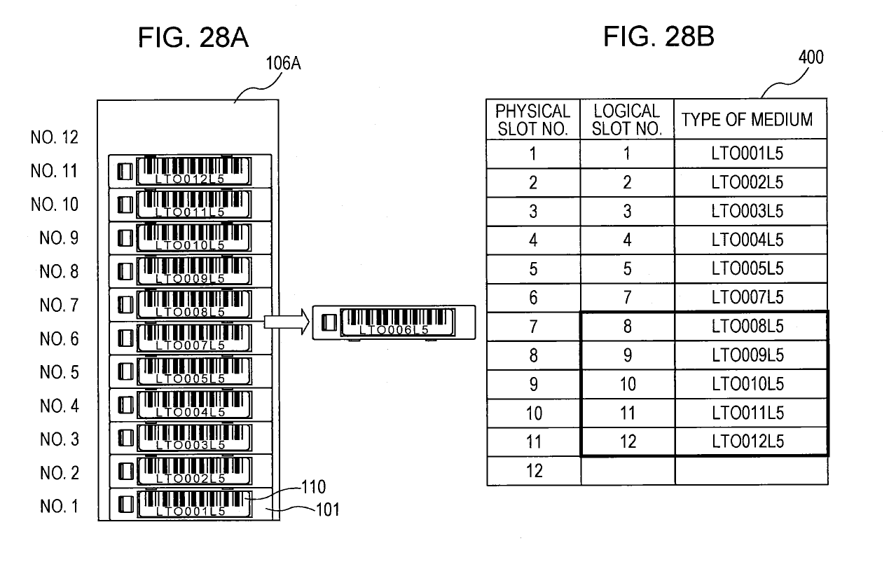

FIGS. 28A and 28B are explanatory drawings illustrating the state in the slot 106A in the Step S11 and the state of the medium management table 400 in the Step S12. It is assumed that the command indicates “an operation to insert a cartridge having a type of medium “LTO006L5” in a logical slot “No. 6” into the drive 103″. In Step S11, the controller 300 controls the transporting robot 104A, and takes out the cartridge having the type of medium “LTO006L5” in the logical slot “No. 6”. Then, as illustrated in FIG. 28A, the cartridges 101 positioned in the physical slots “No. 7” to “No. 12” move to the physical slots “No. 6” to “No. 11”.

In Step S12, the controller 300 rewrites the logical slot numbers and the types of media corresponding the physical slot numbers from “No. 6” to “No. 11” of the medium management table 400 as illustrated in FIG. 28B. The logical slot number and the type of medium corresponding to the physical slot number “No. 12” are provisionally left blank. Alternatively, a logical number of the drive 103 from among the plurality of drives 103 may be filled therein.

Referring to FIG. 26, the controller 300 then controls the transporting robot 104A to insert the taken-out cartridge 101 into the drive 103. Subsequently, in Step S4, the controller 300 notifies the server the fact that the cartridge having the type of medium “LTO006L5” is inserted into the drive 103 via the communication unit 310. Then, the server sends a command indicating writing of data to the cartridge 101 inserted into the drive 103 or reading of data from the cartridge 101 to the library apparatus 100A.

If the command indicates “an operation to store the cartridge in the drive into the cabinet” in Step S1, the controller 300 then controls the transporting robot 104A in Step S21 to take the cartridge 101 from the drive 103 specified by the server. Subsequently, in Step S22, the transporting robot 104A is controlled to return the cartridge 101 to the cabinet 200. In this case, the controller 300 rewrites the medium management table 400 recorded in the memory 320 in Step S23.

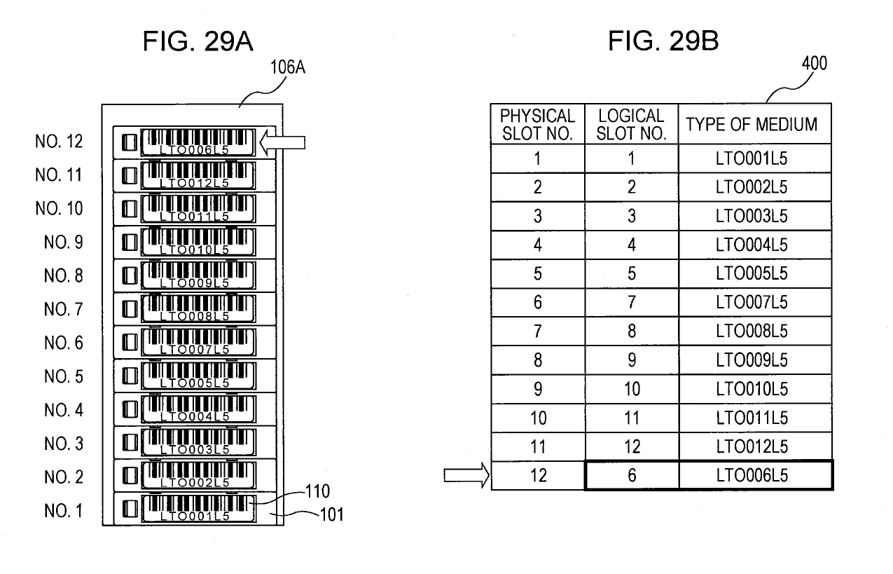

FIGS. 29A and 29B are explanatory drawings illustrating the state in the slot 106A in the Step S22 and the state of the medium management table 400 in the Step S23. It is assumed that the command indicates “an operation to return a cartridge having a type of medium “LTO006L5” in the drive 103 into the cabinet“. In Step S22, the controller 300 returns the cartridge having a type of medium “LTO006L5” to the slot 106A in the cabinet 200. When returning the cartridge 101 to the original 106A, the cartridge 101 is returned to the position of the uppermost physical slot “No. 12”. FIG. 29A illustrates a state in which the cartridge having the type of medium “LTO006L5” is returned to a position of the uppermost slot “No. 12”.

In Step S23, the controller 300 adds “No. 6” and “LTO006L5” to the columns of the logical slot number and the type of medium corresponding to the physical slot number “No. 12” of the medium management table 400 as illustrated in FIG. 29B. Subsequently, in Step S4, the controller 300 notifies the server of the fact that the cartridge having the type of medium “LTO006L5” is returned back to the original slot 106A via the communication unit 310.

In this manner, by the management using the physical slot numbers and the logical slot numbers in the library apparatus 100A, the usage without problem in an operation is achieved without returning the medium to the same physical slot as those of the related art.

The embodiments of the disclosure have been described in detail thus far. However, the disclosure is not limited to the specific embodiments as described above, and may be modified and changed variously within the range of the scope of the disclosure described in claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A library apparatus comprising:
a plurality of cartridges, the cartridges each including
a first fitting portion formed on a first surface, and
a second fitting portion formed on a second surface and configured to fit with a first fitting portion formed on a first surface of another one of the cartridges when being stacked on the other one of the cartridges;
a cabinet having a storage unit, the storage unit being configured to store the cartridges in a stacked manner; and
a transporting unit configured to transport each of the cartridges, the transporting unit including
a pulling unit configured to pull out a first cartridge to be pulled out among the cartridges in a horizontal direction from the storage unit,
a first supporting unit provided under the pulling unit, having a tapered first distal end unit, and configured to insert the first distal end unit between the first cartridge and a second cartridge from among the cartridges positioned under the first cartridge to release the fitting between the first cartridge and the second cartridge, and
a second supporting unit provided above the pulling unit, having a tapered second distal end unit, and configured to insert the second distal end unit between the first cartridge and a third cartridge from among the cartridges stacked on the first cartridge to release the fitting between the first cartridge and the third cartridge.

2. The library apparatus according to claim 1, wherein the transporting unit further comprising:
a pusher configured to push the third cartridge toward the cabinet.

3. The library apparatus according to claim 1, further comprising:
a drive configured to read and write data from and in each of the cartridges; and
a rail provided between the drive and the cabinet, wherein the transporting unit is disposed on the rail.

4. The library apparatus according to claim 3, wherein the transporting unit rotates in a horizontal direction with respect to the rail and moves upward and downward in a perpendicular direction with respect to the rail.

5. The library apparatus according to claim 1, wherein the cabinet includes a stopper provided at an entry of the storage unit for the cartridges and configured to prevent the stored cartridges from coming out of the storage unit.
